(19) United States
(12) Patent Application Publication
(10) Pub. No.: US 2005/0012938 A1
(43) Pub. Date: Jan. 20, 2005

(54) Apparatus and method for detecting wafer position

(76) Inventors: Jun-Ming Chen, Tainan City (TW); Li-Chun Wei, Taichung City (TW)

Correspondence Address: LOWE HAUPTMAN GILMAN & BERNER, LLP, 1700 Diagonal Road, Suite 310, Alexandria, VA, 22314, US

(21) Appl. No.: 10/621,453

(22) Filed: Jul. 18, 2003

(51) Int. Cl. G01B 11/14

(52) U.S. Cl. 356/614

(57) ABSTRACT

Apparatus and method for detecting wafer position is described. The apparatus for detecting wafer position includes a first sensor group and a second sensor group. The first sensor group and the second sensor group both include at least one light emitter and at least one light receiver. In one case, the light emitter is at one side beside a wafer and the light receiver is at the same height with the light emitter at the opposing side beside the wafer. In the other case, the light emitter neighbors the light receiver vertically at the same side beside the wafer. When the apparatus for detecting wafer position is operating, the apparatus determines whether a wafer position is normal by the relative position between the wafer and the sensors (the first sensor group and the second sensor group). Once the wafer position is abnormal and the time interval between the trigger of the first sensor group and the trigger of the second sensor group deviates the predetermined time interval the apparatus for detecting wafer position reports the abnormal event to the equipment including the apparatus to stop the motion of the wafer lifter and the motion of the robot blade in the process chamber. At the same time, the equipment including the apparatus for detecting wafer position alarms people in the production to proceed with troubleshooting.

### BACKGROUND OF THE INVENTION

1. Field of the Invention

The present invention relates to an apparatus for detecting wafer position, especially relates to an apparatus for detecting wafer position of determining whether a wafer position is normal when a wafer lifter raises the wafer after a process in a process chamber.

2. Description of the Prior Art

In the fabrication of semiconductors, each wafer of a plurality of semiconductors always has to pass through hundreds of processes to complete the fabrication of semiconductors thereon. Besides, each wafer has to be put into different equipment to proceed with different processes. If a wafer lot is scrapped because of human mis-operation in the transportation of the wafer cassette, a huge loss will occur. Hence in the fabrication of semiconductors, an automatic wafer transferring system is used to assist wafer transportation.

In the automatic wafer transferring system, sensors are always used to detect wafer position. U.S. Pat. No. 6,298,282 describes using vibration detection sensors to sense whether a wafer position is normal in the vertical direction when the wafer is inserted into or drawn out from a wafer cassette. In addition, U.S. Pat. No. 5,980,194 discloses using multiple optical sensors to detect whether a wafer deviates its normal position on the robot blade.

When a wafer is transferred inside process equipment, robot blades and a wafer lifter are usually used to transfer the wafer into and out from different process chambers in the process equipment. As shown in FIG. 1A, a sectional view inside a process chamber includes a wafer 10, an electrostatic chuck 12, a wafer lifter 16, and a system for detecting the connecting rod position 38. Herein the wafer lifter 16 comprises a pneumatic cylinder 20, an upper gas valve 22 and a lower gas valve 24 of the pneumatic cylinder 20, a connecting rod 30 inside the pneumatic cylinder 20, a position indicator 32 in the lower part of the connecting rod 30, an upper stopper 26 and a lower stopper 28 inside the pneumatic cylinder 20, a circular plate 18 above the connecting rod 30, and four supporting pins 14 above the circular plate 18. The system for detecting the connecting rod position 38 comprises an upper sensor 34 for detecting the highest position of the connecting rod 30 and an lower sensor 36 for detecting the lowest position of the connecting rod 30. The wafer lifter 16 controls the position of the connecting rod 30 by means of pumping compressed dry air (CDA) or nitrogen into or out from the upper gas valve 22 and the lower gas valve 24. When the position of the connecting rod 30 is at the highest point of the wafer lifter 16, the circular plate 18 just adjoins the inner part of the electrostatic chuck 12. In the meantime, the wafer 10 is supported by the four supporting pins 14 to the highest position to be clamped by a robot blade (not shown in the figure) out from the process chamber. When the wafer 10 is removed from the wafer lifter 16, the top view of the electrostatic chuck 12 is as shown in FIG. 1B.

FIG. 2A-2D shows the processes of putting a wafer 210 on a electrostatic chuck 212 and removing the wafer 210 from the electrostatic chuck 212 by means of a wafer lifter 216. As shown in FIG. 2A, after a robot blade (not shown in the figure) transfers a wafer 210 into a process chamber, the wafer 210 is put on the four supporting pins 214. At the same time, nitrogen is pumped into the pneumatic cylinder 220 from the lower gas valve 224 and pumped out from the pneumatic cylinder 220 from the upper gas valve 222. Besides, the connecting rod 230 is at the highest point inside the pneumatic cylinder 220 and against the upper stopper 226. In addition, the position indicator 232 in the lower part of the connecting rod 230 triggers the upper sensor 234 for detecting the highest position of the connecting rod 230 to report that the wafer 210 is put on the four supporting pins 214 to the equipment. Next referring to FIG. 2B, nitrogen is pumped into the pneumatic cylinder 220 from the upper gas valve 222 and pumped out from the pneumatic cylinder 220 from the lower gas valve 224. In the meantime the connecting rod 230 starts to move downward until the connecting rod 230 is at the lowest position inside the pneumatic cylinder 220 and against the lower stopper 228. At the same time, the position indicator 232 in the lower part of the connecting rod 230 triggers the lower sensor 236 for detecting the lowest position of the connecting rod 230 to report that the wafer 210 is put on the electrostatic chuck 212 and is ready for following process steps to the equipment.

In the process, helium is conducted into the electrostatic chuck 212 and ejects onto the wafer 210 backside to uniform the temperature distribution of the wafer 210. Afterwards, the helium will steadily leak out from the edge of the wafer 210 backside to maintain the dynamic equilibrium of the wafer 210, which is balance between both electrostatic force and helium flow. The wafer 210 is steadily secured onto the electrostatic chuck 212. When the process is over, as shown in FIG. 2C, the wafer 210 has to pass through the neutralization of electrostatic charges on the wafer 210 surface before the wafer 210 is removed from the electrostatic chuck 212. If the wafer 210 is removed from the electrostatic chuck 212 without completely neutralizing the electrostatic charges on the wafer 210 surface, the electrostatic force exerted on the wafer 210 surface will not equal to the electrostatic force exerted on the wafer 210 backside. At this time, the wafer 210 will tremble and deviate from its normal position inside the process chamber while the connecting rod 230 moves upward because some part of the wafer 210 is still stuck to the electrostatic chuck 212 and/or the residual helium backside provides the driving force of the deviation of the wafer 210.

As shown in FIG. 2D, when the connecting rod 230 moves upward to the highest position inside the pneumatic cylinder 220, the wafer 210 will not be correctly clamped by a robot blade out from the process chamber. Sometimes the wafer 210 will even be penetrated by the four pins 214 of the wafer lifter 216 or be bumped by the robot blade inserting into the process chamber into fragments. Because the connecting rod 230 is at the highest position inside the pneumatic cylinder 220 and the position indicator 232 triggers the upper sensor 234 for detecting the highest position of the connecting rod 230, the equipment does not alarm until the robot blade reports that the robot blade does not correctly clamp the wafer 210 out from the process chamber to the equipment. In the meantime, the wafer 210 could have been broken into fragments and scatter inside the process chamber, and the equipment has to be stopped to clear the fragments and is started again until the fragments are cleared. This not only affects the normal operation in the production but also shortens the lifetime of the elements of process tool. Accordingly there is a need for determining whether a wafer 210 is in its normal position when the connecting rod 232 of the wafer lifter 216 moves upward.

### SUMMARY OF THE INVENTION

The main purpose of the present invention is to provide an apparatus for detecting wafer position. When a wafer is lifted by a wafer lifter, the apparatus for detecting wafer position determines whether the wafer is in its normal position. Once the wafer deviates its normal position, the apparatus for detecting wafer position will report the abnormal event to the equipment including the apparatus to stop the motion of the wafer lifter and the motion of the robot blade inside the process chamber. At the same time, the equipment will alarm to inform people in the production to proceed with troubleshooting. This prevents the wafer from further being broken into fragments, which will cause the stop of the equipment because of clearing the fragments.

The apparatus for detecting wafer position in the present invention comprises a first sensor group and a second sensor group. The first sensor group and the second sensor group both include at least one light emitter and at least one light receiver. In one case, the light emitter is at one side beside a wafer and the light receiver is at the same height with the light emitter at the opposing side beside the wafer. In the other case, the light emitter neighbors the light receiver vertically at the same side beside the wafer. When the apparatus for detecting wafer position is operating, the apparatus determines whether a wafer position is normal by the relative position between the wafer and the sensors (the first sensor group and the second sensor group). Once the wafer position is abnormal and the time interval between the trigger of the first sensor group and the trigger of the second sensor group deviates the predetermined time interval, the apparatus for detecting wafer position reports the abnormal event to the equipment including the apparatus to stop the motion of the wafer lifter and the motion of the robot blade in the process chamber. At the same time, the equipment including the apparatus for detecting wafer position alarms people in the production to proceed with troubleshooting.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a sectional view of a process chamber in the prior art;

FIG. 1B illustrates a top view of an electrostatic chuck in the prior art;

FIG. 2A shows an illustrative chart that a wafer is put on a wafer lifter at its highest position in the prior art;

FIG. 2B shows an illustrative chart that a wafer is put on a wafer lifter at its lowest position in the prior art;

FIG. 2C shows an illustrative chart that a wafer deviates its normal position on a wafer lifter when the wafer lifter is at its lowest position in the prior art;

FIG. 2D shows an illustrative chart that two opposing sides of a wafer are at different height when a wafer lifter moves upward and the wafer deviates its normal position on the wafer lifter in the prior art;

FIG. 3A shows an illustrative chart that a wafer is put on a wafer lifter at its highest position FIG. 3B shows an illustrative chart that a wafer is put on a wafer lifter at its lowest position FIG. 3C shows an illustrative chart that a wafer deviates its normal position on a wafer lifter when the wafer lifter is at its lowest position;

FIG. 3D shows an illustrative chart that two opposing sides of a wafer are at different height when a wafer lifter moves upward and the wafer deviates its normal position on the wafer lifter;

FIG. 4A shows an illustrative chart that one light receiver receives light emitted from one light emitter when the light emitter is at one side beside a wafer and the light receiver is at the same height with the light emitter at the opposing side beside the wafer;

FIG. 4B shows an illustrative chart that one wafer blocks light emitted from one light emitter to trigger the sensor when the light emitter is at one side beside a wafer and the light receiver is at the same height with the light emitter at the opposing side beside the wafer;

FIG. 4C shows an illustrative chart that one light emitter neighbors one light receiver vertically at the same side beside the wafer;

FIG. 4D shows an illustrative chart that one light receiver receives light emitted from one light emitter and reflected by a wafer to trigger a sensor when the light emitter neighbors the light receiver vertically at the same side beside the wafer;

FIG. 5A shows an illustrative chart that the upper part and the lower part of a process chamber both includes two sensors and that a wafer locates between light emitters and light receivers in the normal position;

FIG. 5B shows an illustrative chart that the upper part and the lower part of a process chamber both includes two sensors and that a wafer locates between light emitters and light receivers in one abnormal position; and

FIG. 5C shows an illustrative chart that the upper part and the lower part of a process chamber both includes two sensors and that a wafer locates between light emitters and light receivers in the other one abnormal position.

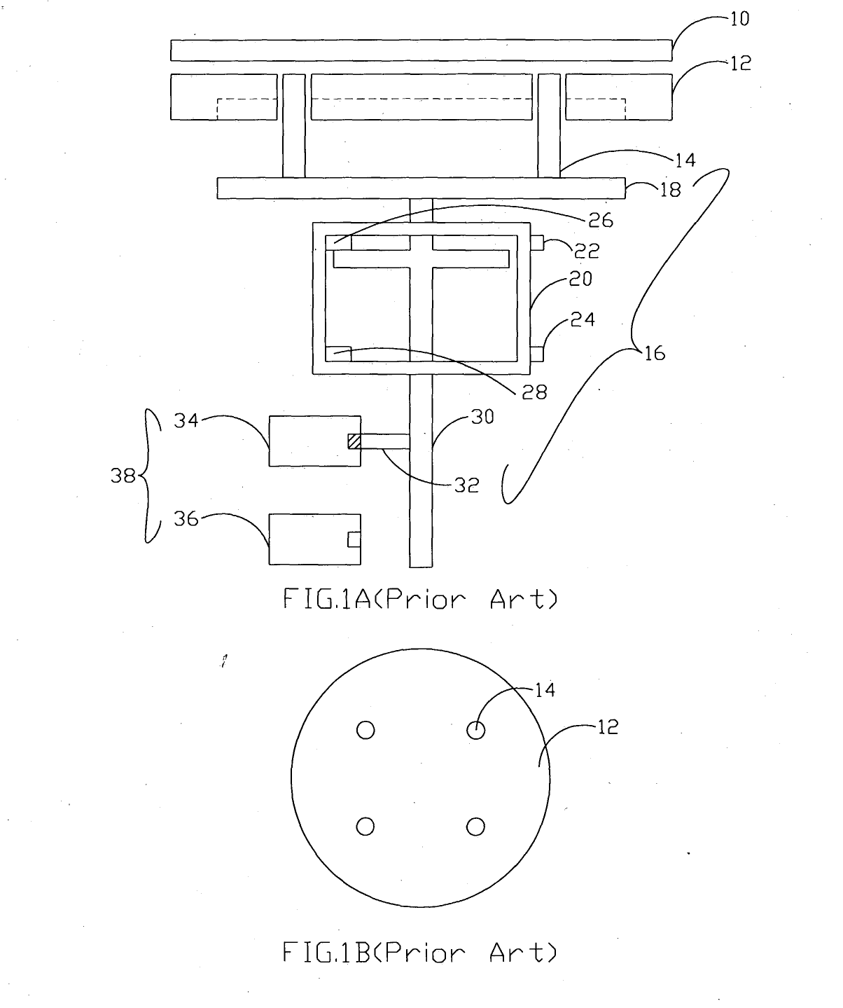

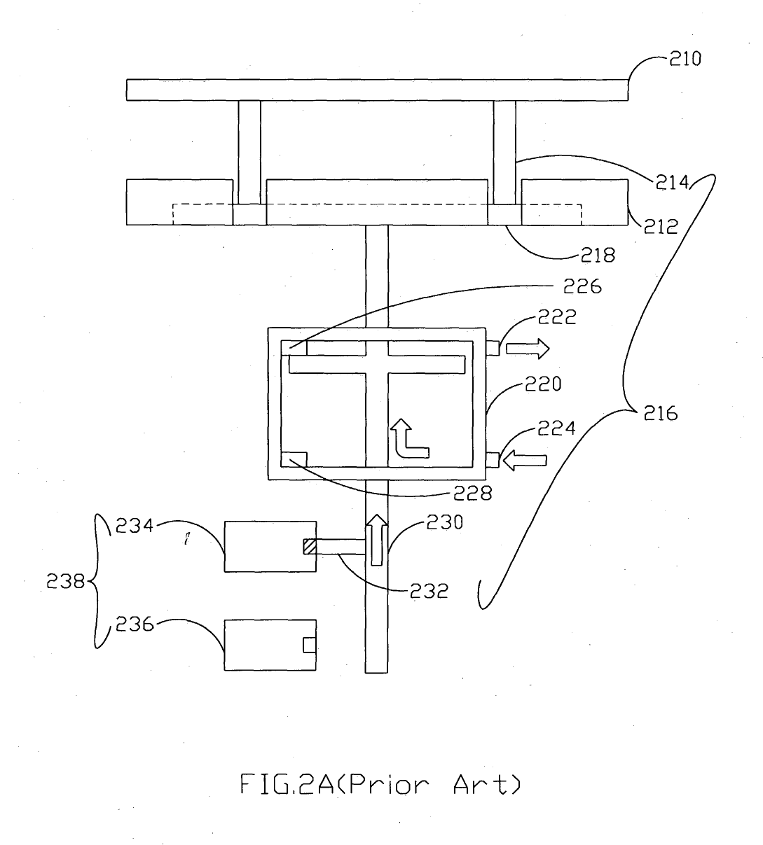

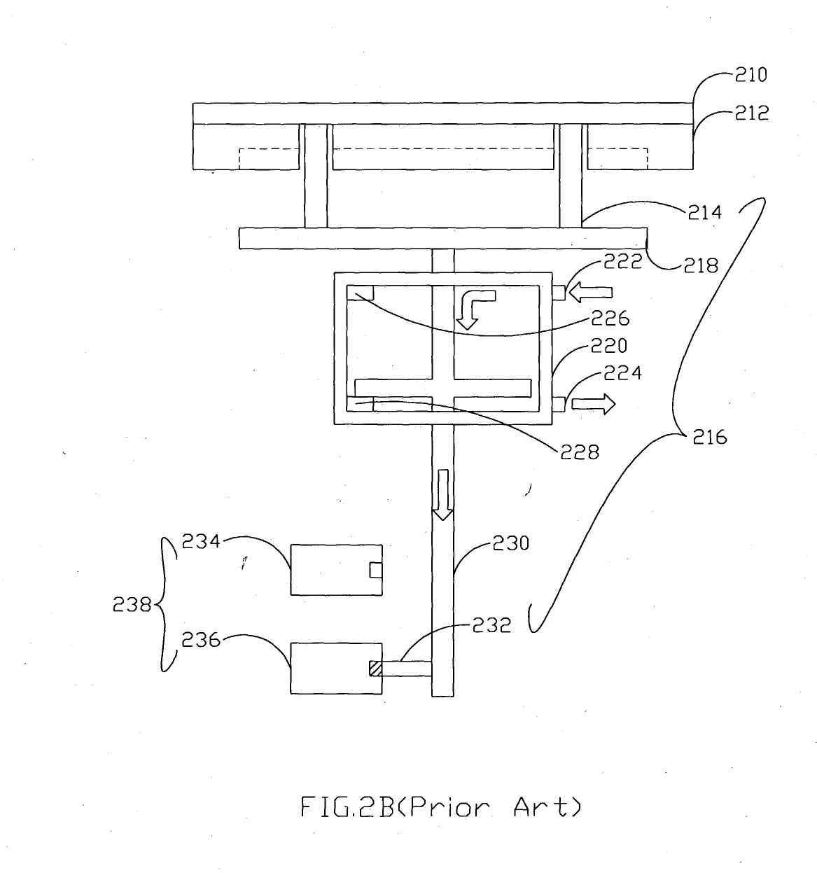

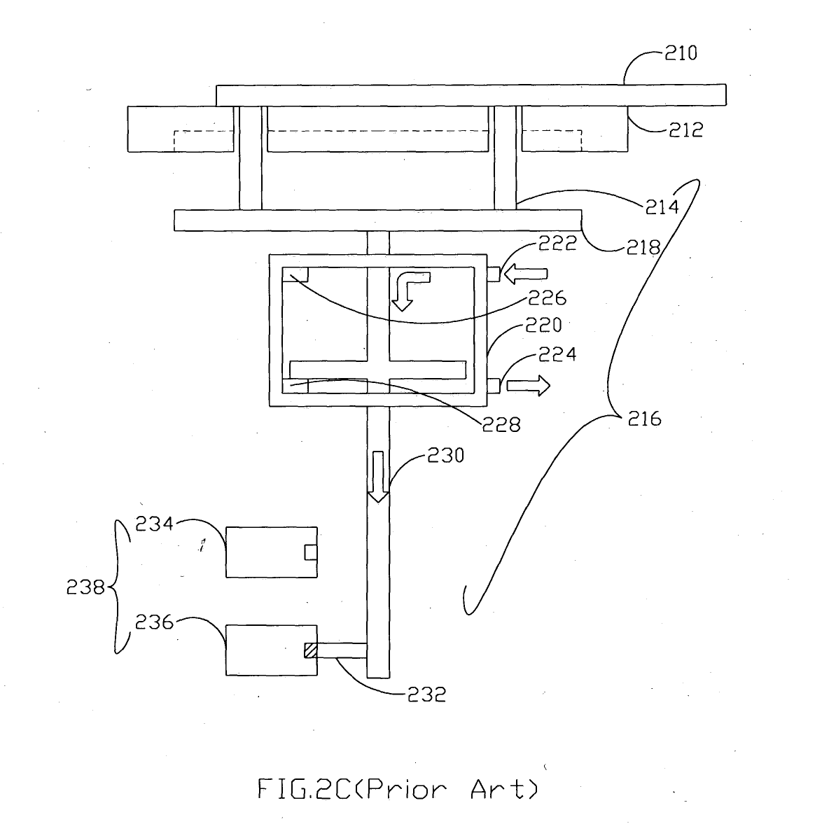

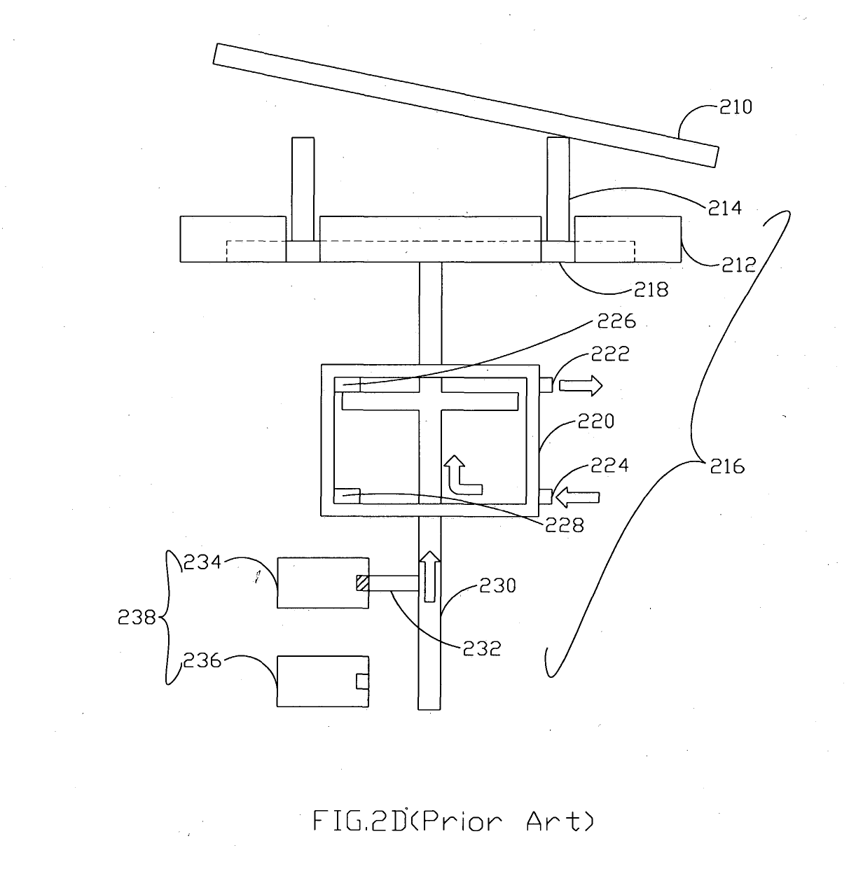

### DESCRIPTION OF THE PREFERRED EMBODIMENT

Some embodiments of the invention will be described exquisitely as below. Besides, the invention can also be practiced extensively in other embodiments. That is to say, the scope of the invention should not be restricted by the proposed embodiments. The scope of the invention should be based on the claims proposed later.

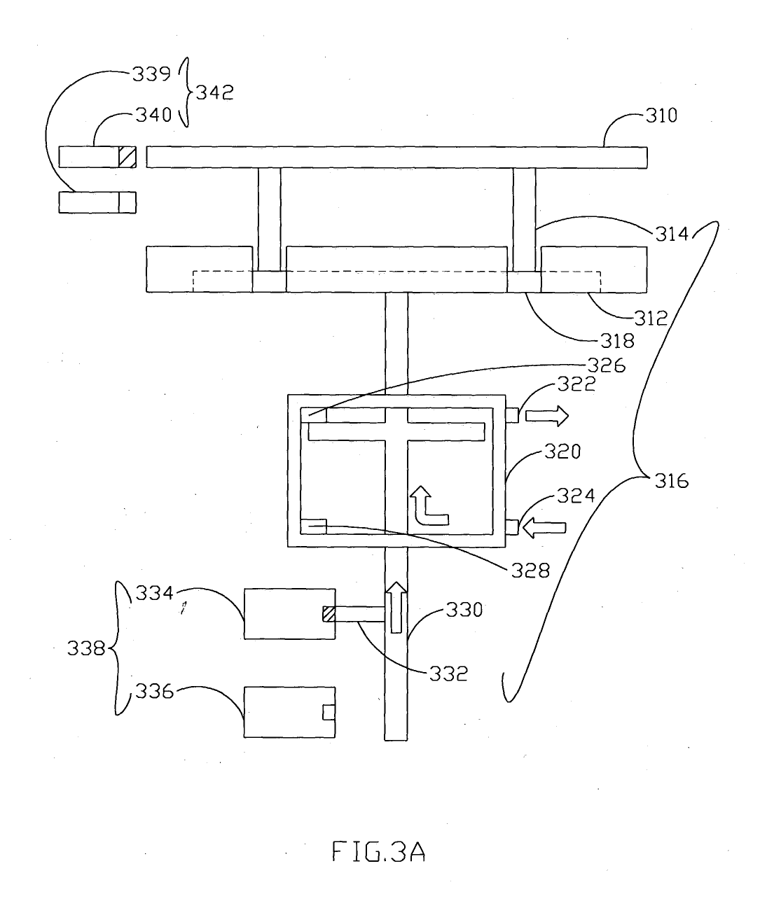

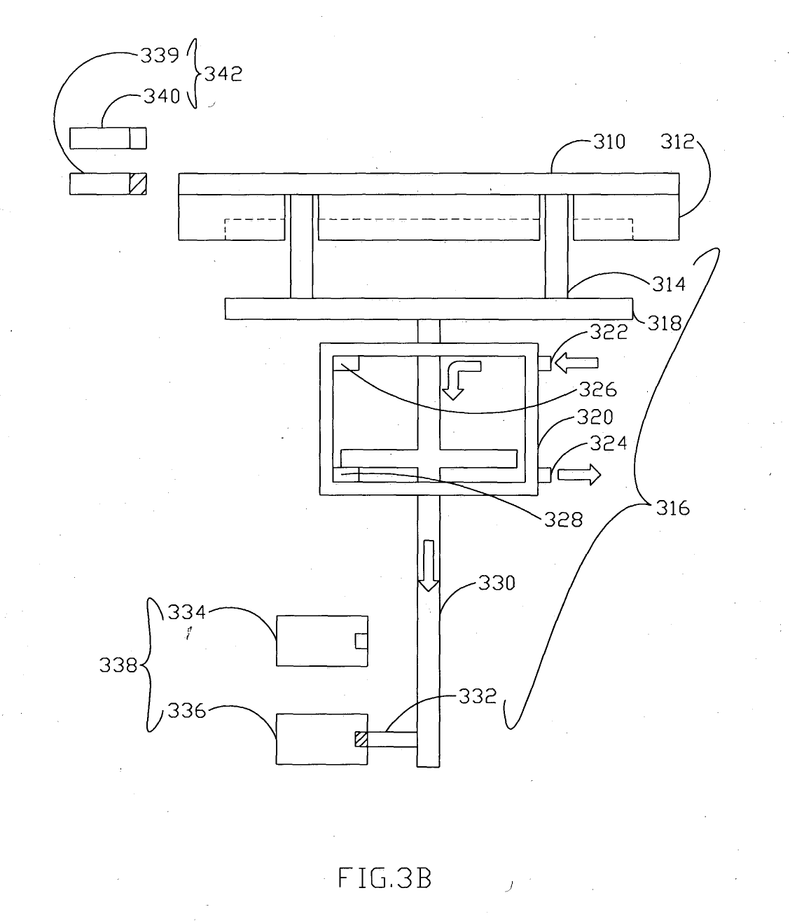

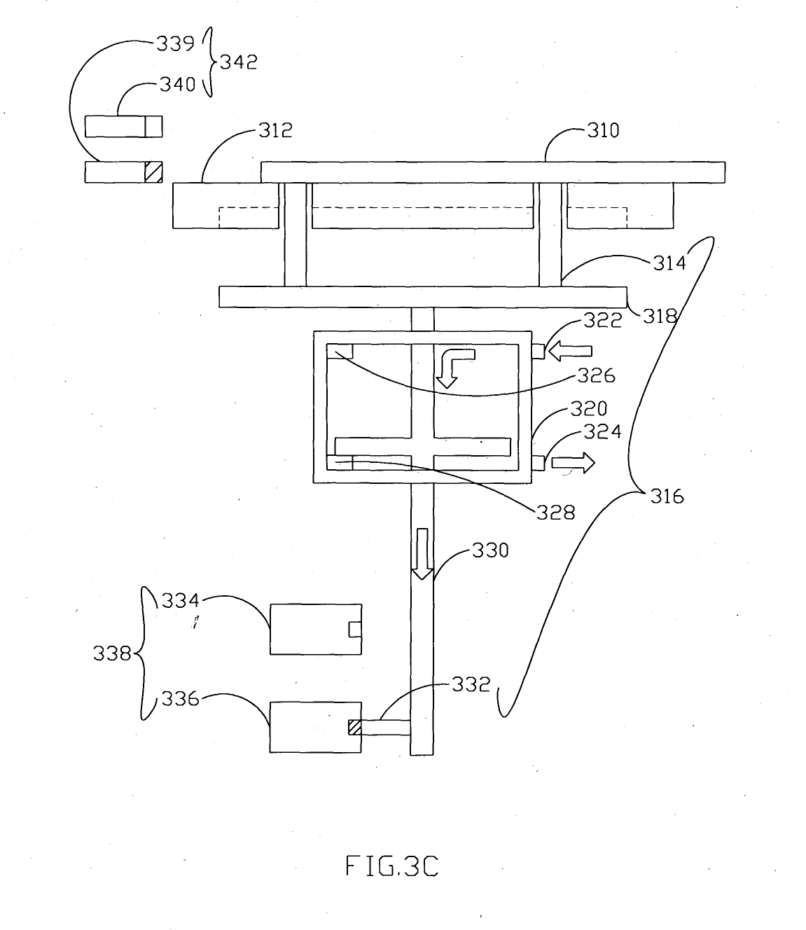

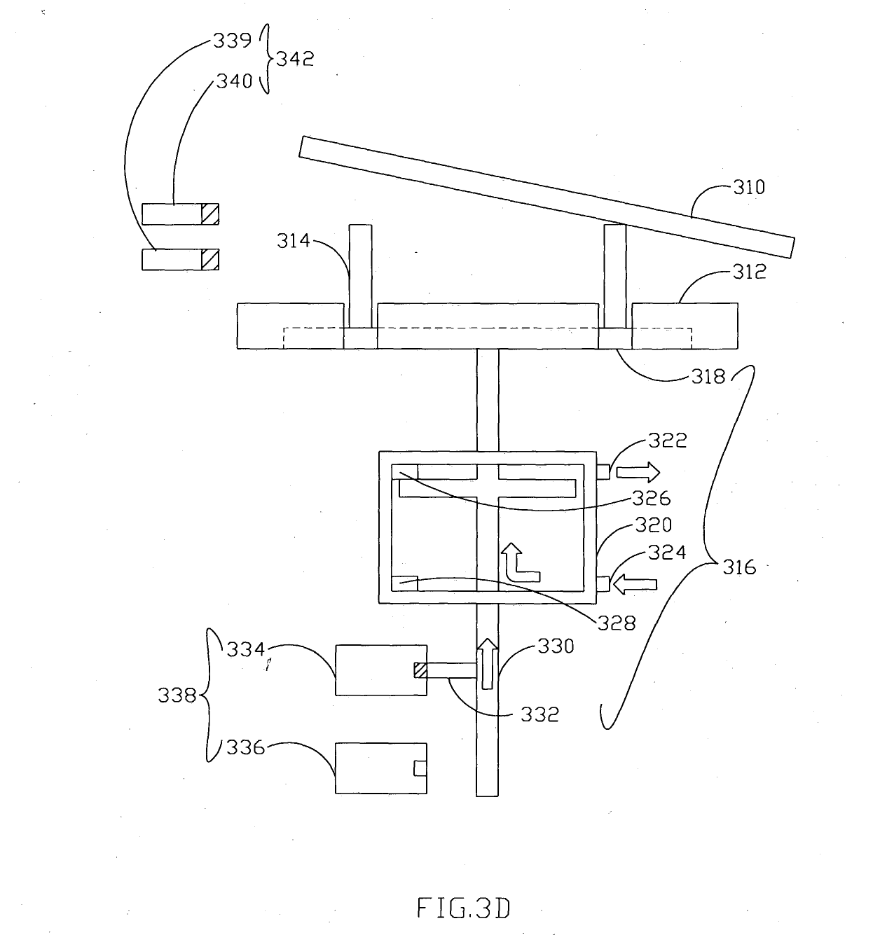

The sectional view of a process chamber is as shown in FIG. 3A after the apparatus for detecting wafer position in the present invention is added. The sectional view of the process chamber includes a wafer 310, an electrostatic chuck 312, a wafer lifter 316, a system for detecting the connecting rod position 338 and an apparatus for detecting wafer position 342. Herein the wafer lifter 316 comprises a pneumatic cylinder 320, an upper gas valve 322 and a lower gas valve 324 of the pneumatic cylinder 320, a connecting rod 330 inside the pneumatic cylinder 320, a position indicator 332 in the lower part of the connecting rod 330, an upper stopper 326 and a lower stopper 328 inside the pneumatic cylinder 320, a circular plate 318 above the connecting rod 330, and four supporting pins 314 above the circular plate 318. The system for detecting the connecting rod position 338 comprises an upper sensor 334 for detecting the highest position of the connecting rod 330 and an lower sensor 336 for detecting the lowest position of the connecting rod 330. The apparatus for detecting wafer position 342 comprises a first sensor group 339 and a second sensor group 340. The wafer lifter 316 controls the position of the connecting rod 330 by means of pumping nitrogen into or out from the upper gas valve 322 and the lower gas valve 324. When the wafer 310 is transferred by the wafer lifter 316, the wafer will trigger the first sensor group 339 or the second sensor group 340 by passing the same height level of the first sensor group 339 or the second sensor group 340 to report whether the wafer is at the normal position to the equipment.

FIG. 3A-3D shows the processes of putting a wafer 310 on a electrostatic chuck 312 and removing a wafer 310 from the electrostatic chuck 312 by means of a wafer lifter 316. As shown in FIG. 3A, after a robot blade (not shown in the figure) transfers a wafer 310 into a process chamber, the wafer 310 is put on the four supporting pins 314. At the same time, nitrogen is pumped into the pneumatic cylinder 320 from the lower gas valve 324 and pumped out from the pneumatic cylinder 320 from the upper gas valve 322. Besides, the connecting rod 330 is at the highest point inside the pneumatic cylinder 320 and against the upper stopper 326. In addition, the position indicator 332 in the lower part of the connecting rod 330 triggers the upper sensor 334 for detecting the highest position of the connecting rod 330. At the same time the wafer 310 also triggers the second sensor group 340 to report that the wafer 310 is put on the four supporting pins 314 to the equipment. Next referring to FIG. 3B, nitrogen is pumped into the pneumatic cylinder 320 from the upper gas valve 322 and pumped out from the pneumatic cylinder 320 from the lower gas valve 324. In the meantime the connecting rod 330 starts to move downward until the connecting rod 330 is at the lowest position inside the pneumatic cylinder 320 and against the lower stopper 328. At the same time, the position indicator 332 in the lower part of the connecting rod 330 triggers the lower sensor 336 for detecting the lowest position of the connecting rod 330. Besides, the wafer 310 also triggers the first sensor group 339 to report that the wafer 310 is put on the electrostatic chuck 312 and is ready for following process steps to the equipment.

In the process, helium is conducted into the electrostatic chuck 312 and ejects onto the wafer 310 backside to uniform the temperature distribution of the wafer 310. Afterwards, the helium will steadily leak out from the edge of the wafer 310 backside to maintain the dynamic equilibrium of the wafer 310, which is balance between both electrostatic force and helium flow. The wafer 310 is steadily secured onto the electrostatic chuck 312. When the process is over, as shown in FIG. 3C, the wafer 310 has to pass through the neutralization of electrostatic charges on the wafer 310 surface before the wafer 310 is removed from the electrostatic chuck 312. If the wafer 310 is removed from the electrostatic chuck 312 without completely neutralizing the electrostatic charges on the wafer 310 surface, the electrostatic force exerted on the wafer 310 surface will not equal to the electrostatic force exerted on the wafer 310 backside. At this time, the wafer 310 will tremble and deviate from its normal position inside the process chamber while the connecting rod 330 moves upward because some part of the wafer 310 is still stuck to the electrostatic chuck 312 and/or the residual helium backside provides the driving force of the deviation of the wafer 310.

As shown in FIG. 3D, when the connecting rod 330 moves upward to the highest position inside the pneumatic cylinder 320, the wafer 310 simultaneously triggers the first sensor group 339 and the second sensor group 340 of the apparatus for detecting wafer position 342 because the wafer 310 deviates from its normal position on the four supporting pins 314 and the time interval between the trigger of the first sensor group 339 and the trigger of the second sensor group 340 deviates the predetermined time interval. In the meantime, the apparatus for detecting wafer position 342 reports the abnormal event to the equipment including the apparatus to stop the motion of the wafer lifter 316 and the motion of the robot blade (not shown in the figure) in the process chamber. In addition, the equipment including the apparatus for detecting wafer position 342 alarms people in the production to proceed with troubleshooting.

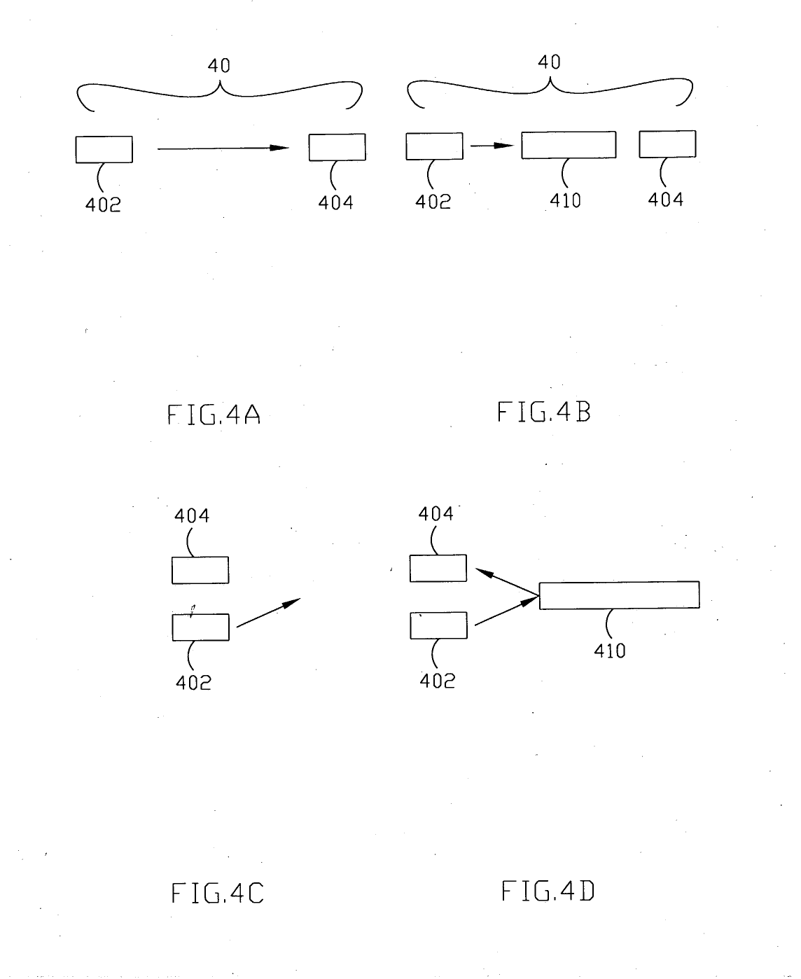

The operating rules of the sensor groups of the apparatus for detecting wafer position is as shown from FIG. 4A-4D. As shown in FIG. 4A, a sensor 40 includes a light emitter 402 and a light receiver 404. The light emitter 402 is at one side beside a wafer 410 and the light receiver 404 is at the same height with the light emitter 402 at the opposing side beside the wafer 410. As shown in FIG. 4B, in the meantime the sensor 40 detects the position of the wafer 410 by means of determining whether the wafer 410 blocks light emitted from the light emitter 402.

As shown in FIG. 4C, the light emitter 402 neighbors the light receiver 404 vertically at the same side beside the wafer 410. Now referring to FIG. 4D, the sensor 40 detects the position of the wafer 410 by means of determining whether the light receiver 404 receives light reflected by wafer 410, light which is emitted from the light emitter 402.

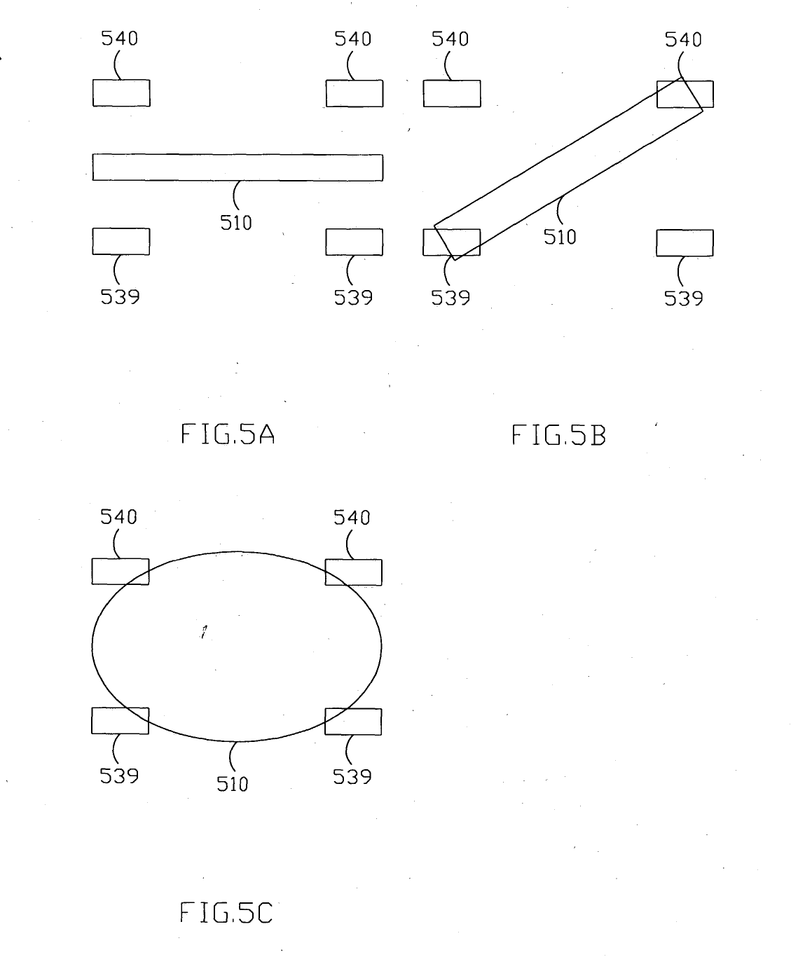

In one preferred embodiment of the present invention, the first sensor group and the second sensor group of the apparatus for detecting wafer position both include two sensors. The two sensors individually include two light emitters and two light receivers. FIG. 5A shows a side view of the apparatus for detecting wafer position. In the normal situation, the wafer 510 parallels the first sensor group 539 and the second sensor group 540. In one abnormal situation as shown in FIG. 5B, the wafer 510 triggers one sensor of the first sensor group 539 and one sensor of the second sensor group 540 when the normal direction of the rotation of the wafer 510 is perpendicular to the paper. In another abnormal situation as shown in FIG. 5C, the wafer 510 simultaneously triggers the first sensor group and the second sensor group when the normal direction of the rotation of the wafer 510 is parallel with the paper. In the aforementioned two abnormal situations, the apparatus for detecting wafer position reports the normal event to the equipment including the apparatus to stop the motion of the wafer lifter and the motion of the robot blade inside the process chamber. At the same time, the equipment will alarm to inform people in the production to proceed with troubleshooting. This prevents the wafer 510 from further being broken into fragments, which will cause the stop of the equipment because of clearing the fragments and/or particle defects.

What is said above is only a preferred embodiment of the invention, which is not to be used to limit the claims of the invention; any change of equal effect or modifications that do not depart from the essence displayed by the invention should be limited in what is claimed in the following.

1. An apparatus for detecting wafer position, comprising:
a first sensor group, wherein said first sensor group includes at least one first light emitter and at least one first light receiver to detect a first wafer position; and
a second sensor group, wherein said second sensor group includes at least one second light emitter and at least one second light receiver to detect a second wafer position.

2. The apparatus for detecting wafer position according to claim 1, wherein said first light emitter is at one side beside said wafer and said first light receiver is at the same height with said first light emitter at the opposing side beside said wafer, and said first light emitter and said first light receiver detect said first wafer position by determining whether said wafer blocks light emitted by said first light emitter.

3. The apparatus for detecting wafer position according to claim 1, wherein said first light emitter neighbors said first light receiver vertically at the same side beside said wafer, and said first light emitter and said first light receiver detect said first wafer position by determining whether said first light receiver receives said light emitted from said first light emitter and reflected by said wafer.

4. The apparatus for detecting wafer position according to claim 1, wherein said second light emitter is at one side beside said wafer and said second light receiver is at the same height with said second light emitter at the opposing side beside said wafer, and said second light emitter and said second light receiver detect said second wafer position by determining whether said wafer blocks light emitted by said second light emitter.

5. The apparatus for detecting wafer position according to claim 1, wherein said second light emitter neighbors said second light receiver vertically at the same side beside said wafer, and said second light emitter and said second light receiver detect said second wafer position by determining whether said second light receiver receives said light emitted from said second light emitter and reflected by said wafer.

6. A method for detecting wafer position, comprising:
providing a wafer lifter and putting a wafer on said wafer lifter, wherein a connecting rod of said wafer lifter is at the lowest position inside said wafer lifter;
lifting said wafer by means of said wafer lifter, wherein said wafer triggers a first sensor group when said wafer passes through light emitted by said first sensor group and said first sensor group detects a first wafer position;
lifting said wafer continuously until said wafer completely passes by said first sensor group, wherein said wafer triggers said first sensor group again and said first sensor group recognizes that said wafer has passed by said first wafer position completely;
lifting said wafer continuously until said wafer passes a second sensor group, wherein said wafer triggers said second sensor group, and in a normal situation, said connecting rod of said wafer lifter is at the highest position inside said wafer lifter and afterwards a robot blade enters a process chamber including said wafer lifter to clamp said wafer; and
in abnormal situations, when two opposing sides of said wafer are not at the same height level, said wafer does not simultaneously block a plurality of light beams emitted by a plurality of first light emitters of said first sensor group and does not simultaneously block a plurality of light beams emitted by a plurality of light emitters of said second sensor group, or said wafer simultaneously blocks said light beams emitted by said first sensor group and light beams emitted by said second sensor group, and the time interval between the trigger of the first sensor group and the trigger of the second sensor group deviates the predetermined time interval, at the moment, said robot blade and said wafer lifter are stopped by equipment including said wafer lifter and said equipment alarms to people in a operating line to proceed with trouble shooting.

7. The method for detecting wafer position according to claim 6, wherein said first sensor group includes at least one first light emitter and at least one first light receiver.

8. The method for detecting wafer position according to claim 7, wherein said first light emitter is at one side beside said wafer and said first light receiver is at the same height with said first light emitter at the opposing side beside said wafer, and said first light emitter and said first light receiver detect said first wafer position by determining whether said wafer blocks light emitted by said first light emitter.

9. The method for detecting wafer position according to claim 7, wherein said first light emitter neighbors said first light receiver vertically at the same side beside said wafer, and said first light emitter and said first light receiver detect said first wafer position by determining whether said first light receiver receives said light emitted from said first light emitter and reflected by said wafer.

10. The method for detecting wafer position according to claim 6, wherein said second sensor group includes at least one second light emitter and at least one second light receiver.

11. The method for detecting wafer position according to claim 10, wherein said second light emitter is at one side beside said wafer and said second light receiver is at the same height with said second light emitter at the opposing side beside said wafer, and said second light emitter and said second light receiver detect said second wafer position by determining whether said wafer blocks light emitted by said second light emitter.

12. The method for detecting wafer position according to claim 10, wherein said second light emitter neighbors said second light receiver vertically at the same side beside said wafer, and said second light emitter and said second light receiver detect said second wafer position by determining whether said second light receiver receives said light emitted from said second light emitter and reflected by said wafer.
